(19) United States
(12) Patent Application Publication
(10) Pub. No.: US 2021/0094650 A1
(43) Pub. Date: Apr. 1, 2021

(54) PROGRESSIVE CYCLE SUSPENSION LINKAGE

(71) Applicant: Christopher Sanders, Layton, UT (US)

(72) Inventor: Christopher Sanders, Layton, UT (US)

(21) Appl. No.: 16/590,286

(22) Filed: Oct. 1, 2019

(51) Int. Cl. B62K 25/28

(52) U.S. Cl. CPC B62K 25/286; B62K 25/283

(57) ABSTRACT

A linkage for suspending the swing arm of a cycle including a trailing link and a forward link shaped to seesaw on a midpoint so as to permit exaggerated travel of a shock-absorber relative to the swing arm. The linkage is configured to prevent inferior protrusion of the linage below the swing arm while maintaining links and shock absorber in a co-planar orientation.

### FIELD OF THE INVENTION

This invention relates to vehicle suspension systems, and more particularly relates to linkages for rear suspension of cycles, including bicycles and motorcycles.

### BACKGROUND

### Description of the Related Art

The present invention constitutes an addition and improvement to standard linkages known and commonly available in the art for suspending mounted wheels (particularly rear wheels) on bicycles, motorcycles, tricycles and the like (collectively “cycles”).

The application discloses a drive wheel suspension system for cycles employing a pivotably-mounted articulating bar and triangle, or linkage or kinematic chain, which interconnects swing arm(s) and shock absorber(s), wherein the swing arm(s) are torsionally connected to enable rotation of the swing arm only about a horizontal axis transverse to a cycle body.

Motorcycles have long employed a rear suspension including a rear wheel support frame, or swing arm, which is pivotally mounted about a transverse horizontal axis to a cycle frame body. Many deficiencies plague the art particularly because of the limited area for location of the linkage mechanism below the shock absorber. Linkages and shock absorbers extend between the cycle body frame and the swing arms in many embodiments. These linkages permit varying rates of “rise” of the linkage relative to the rear wheel—meaning linkages extend the distance through which the shock absorber may compress and retract relative the distance which a wheel mounted on the swing arm compresses. Progressive linkages are known in the art which result in an increasing rise relative to the rate of rise of the swing arm; though these linkages are designed such that they extend inferiorly to the swing arm, exposing the linkages themselves to obstacles on ground surfaces, breakage, and impact.

Through the employment of the taught and recited linkage system herein, a linkage is realized which does not inferiorly protrude from the swing arm and which allows centerline positioning of the shock absorber, wherein the damping and resistance force generated by the shock absorber between the cycle body frame and the swing arm vis-à-vis the shock absorber is optimized to cure the above deficiencies in the art. None of the linkages known in the art address these deficiencies. There is a substantial need in the art for an improved progressive linkage.

### SUMMARY

From the foregoing discussion, it should be apparent that a need exists for a progressive cycle suspension linkage for a dirt bike application in which the linkage operates superiorly to the swing arm.

The present invention has been developed in response to the present state of the art, and in particular, in response to the problems and needs in the art which have arisen with other linkages.

Accordingly, the present invention has been developed to provide a progressive linkage suspension assembly adapted to suspend a swing arm pivotably connected to a cycle body frame, the linkage suspension assembly comprising: a first link pivotably affixed to cycle body frame at a distal end, the first link defining a bore at the distal end, the first link pivotably affixed to a chevron-shaped second bar having a distal end and a proximal end; the chevron-shaped link hingedly affixed at a midpoint to a swing arm and adapted to seesaw about the midpoint, the chevron-shaped link having a proximal end comprising a bifurcate bracket adapted to affix to a shock absorber, the chevron-shaped link defining: a distal bore at a distal end of the chevron-shaped link adapted to hingedly affix to the first link; and a proximal bore at the proximal end adapted to hingedly affix the bifurcate bracket to the shock absorber; wherein the first link and the chevron-shaped link both articulate on separate axes transverse to the cycle body frame.

The distal end of the chevron-shaped link may further comprise a second bifurcate bracket adapted to hingedly affix the chevron-shaped link to the first link. The midpoint of the chevron-shaped link may extend inferiorly to the distal bore and the proximal bore.

A distance between the midpoint of the chevron-shaped link and the proximal bore of the chevron-shaped link may exceed the distance between the midpoint and the distal bore of the chevron-shaped link.

In both upward and downward configurations the linkage assembly may rise superiorly to the swing arm.

A second progressive linkage suspension assembly adapted to suspend a swing arm pivotably connected to a cycle body frame is provided, the linkage suspension assembly comprising: a first link pivotably affixed to cycle body frame at a distal end, the first link defining a bore at the distal end, the first link pivotably affixed to a second link having a distal end and a proximal end; the second link hingedly affixed at a midpoint to a swing arm and adapted to seesaw about the midpoint, the second link having a proximal end comprising a bifurcate bracket adapted to affix to a shock absorber, the second link defining: a distal bore at a distal end of the second link adapted to hingedly affix to the first link; and a proximal bore at the proximal end adapted to hingedly affix the bifurcate bracket to the shock absorber; wherein the first link and the second link both articulate on separate axes transverse to the cycle body frame.

The second link is one of: bowed, triangular, and chevron-shaped from a side perspective. The midpoint of the second link may be inferior to the distal bore and the proximal bore.

A distance between the midpoint of the second link and the proximal bore of the second link may exceed the distance between the midpoint and the distal bore.

The distance between the midpoint of the second link and the proximal bore of the second link may exceed the distance between the midpoint and the distal bore by 10%-400%.

In both upward and downward configurations, the linkage assembly rises superiorly to the swing arm. The distal end of the chevron-shaped link may further comprise a second bifurcate bracket adapted to hingedly affix the chevron-shaped link to the first link.

The first link and the second link may pivot co-planarly with the shock absorber.

A third progressive linkage suspension assembly adapted to suspend a swing arm pivotably connected to a cycle body frame is provided, the linkage suspension assembly comprising: a first link pivotably affixed to cycle body frame at a distal end, the first link defining a bore at the distal end, the first link pivotably affixed to a second link having a distal end and a proximal end; the second link hingedly affixed at a midpoint to a swing arm and adapted to seesaw about the midpoint, the second link having a proximal end comprising a bifurcate bracket adapted to affix to a shock absorber, the second link defining: a distal bore at a distal end of the second link adapted to hingedly affix to the first link; and a proximal bore at the proximal end adapted to hingedly affix the bifurcate bracket to the shock absorber; wherein the first link and the second link both pivot in co-planarly with the shock absorber.

A distance between the midpoint of the second link and the proximal bore of the second link may exceed the distance between the midpoint and the distal bore such that longitudinal movement of the proximal end of first link within plane is exaggerated with respect to longitudinal movement the proximal end of the second link within plane.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top, rearward isometric perspective view of a cycle linkage 100 in accordance with the present invention;

FIG. 2 is a side perspective view of a cycle linkage 200 in accordance with the present invention;

FIG. 3 is an environmental, side perspective view of a cycle linkage in an upwards configuration in accordance with the present invention;

FIG. 4 is an environmental, side perspective view of a cycle linkage in a downward configuration in accordance with the present invention;

FIG. 5 is an environmental, side perspective view of a cycle linkage in an upward configuration in accordance with the present invention;

FIG. 6 is an environmental, side perspective view of a cycle linkage in a downward configuration in accordance with the present invention;

FIG. 7 is an environmental, isometric perspective view of a cycle linkage in an upward configuration in accordance with the present invention; and

FIG. 8 is an environmental, isometric perspective view of a cycle linkage in a downward configuration in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

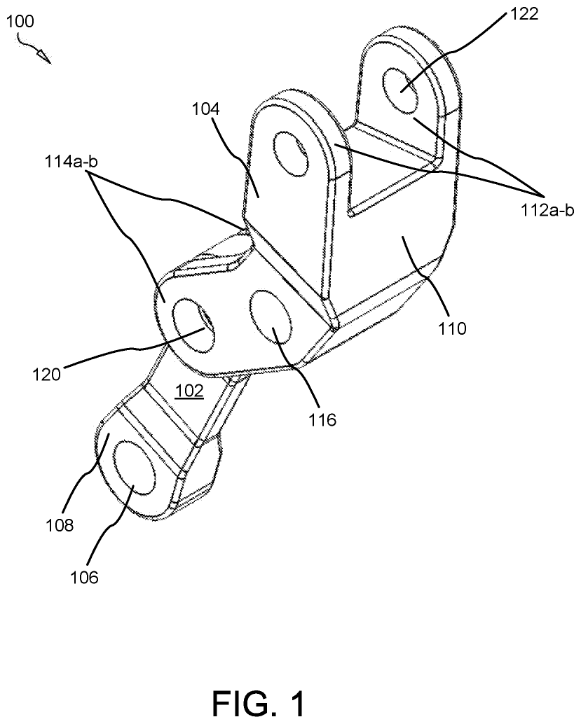

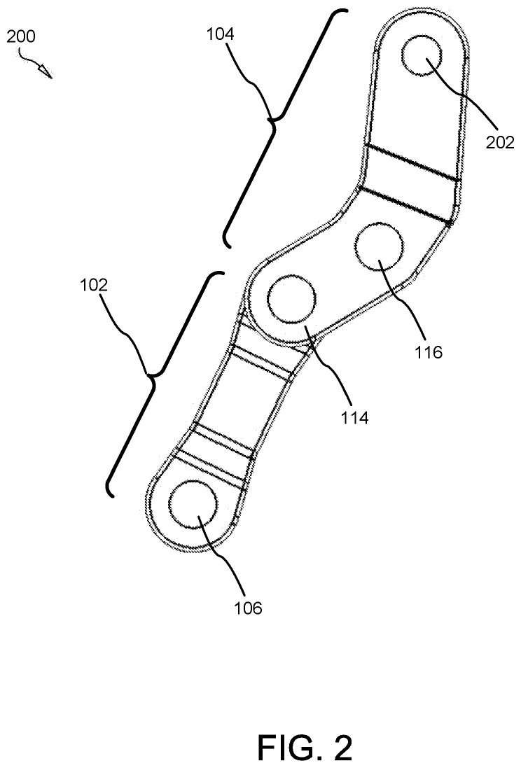

FIGS. 1-2 illustrate a cycle linkage 100 in accordance with the present invention.

The linkage 100 comprises a trailing link 102 having a proximal end and a distal end 108 (the link 102 alternatively cited as a trailing bar 102 or arm 102). The distal end 108 defines a bore 106, or aperture 106, adapted to receive a bolt and pivotably join the trailing link 102 to a cycle body frame 306 further described below. In various embodiments, the bore 106 receives a sleeve which inserts into the bore 106 and which receives a bolt.

The trailing link 102 may alternatively pivotably mount to the cycle body frame 306 using other means known to those of skill in the art, including journaling the trailing link 102 to the cycle body frame 306.

The trailing link 102 in the shown embodiments mounts within prongs, clevis lugs, or forked mounts on a cycle body frame 306. In alternative embodiments, the trailing link 102 itself may alternatively comprise a bifurcate bracket at the distal end 108 adapted to mount to a prong or protuberance on the cycle body frame 306.

The mounting point between the trailing link 102 and the cycle body frame 306 defines a link pivot axis about which the trailing link 102 rotates axially in response to tensile and compressive force being applied to the swing arm through the wheel, and to the one or more shock absorbers 302 via the swing arm.

The taught linkage therefor employs a single trailing link 102; and bowed, or chevron-shaped, forward linkage 104.

The linkage comprises a chevron-shaped forward link 104. The chevron-shaped link 104 comprises two sets of bifurcate brackets. The first set of bifurcate brackets comprises prongs 114a-b and the second set of bifurcate brackets comprises prongs 112a-b.

The chevron-shaped link 104 is chevron-shaped, or v-shaped, from a side perspective. The link 104 may alternatively be bowed, concave, or triangular from a side perspective.

The first set of bifurcate brackets defines a bore 120 through which a bolt inserts. The trailing link 102 is pivotably joined to the forward chevron-shaped link 104 at the bore 120. The prongs 114a-b receive the proximal end of the first link 102.

The second set of bifurcate brackets mates with the lower end of shock absorber 302 using a bore 122. The link 104 defines a bore 116, or aperture 116, which pivotably joins with brackets 702 affixed to the swing arm 304 securing a wheel. The link 104 may form a revolute joint with the swing arm 304.

The chevron-shaped link 104 seesaws about the transverse axis point formed at the bore 116, allowing compounded progressive travel of the link 104 relative to a mounted wheel and the swing arm 304. The link 104 acts as a lever.

The distance between bore 120 and bore 116 (the “distal distance”), and the distance between bore 116 and bore 122 (the “second distance”) is not uniform. The second distance exceed the first distance in the preferred embodiment. The second distance may exceed the first distance by 10-400%. The link 104 may be journaled to the cycle body frame 306.

The links 102, 104 may be cast from aluminum, steel, titanium, metal alloys, fiberglass, carbon fiber, polymeric materials or other rigid materials known to those of skill in the art.

The distal end, or rearward end, of the link 102 is furthest away from the shock absorber, while the proximal end, or forward end, of the link 102 is closer to the shock absorber.

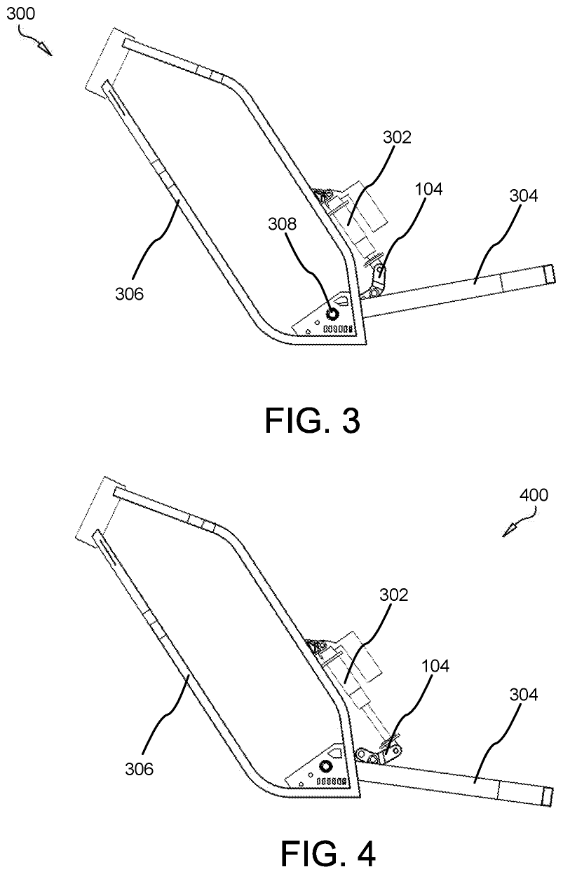

FIG. 3 is an environmental, side perspective view of a cycle linkage in an upwards configuration in accordance with the present invention.

A transverse horizontal axis is indicated at 308. A shock absorber 302 positions above the chevron-shaped link 104 and linkage 100. The shock absorber 302 may comprise any mechanical or hydraulic device designed to absorb and damp shock impulses by converting the kinetic energy of the shock (originating with potholes, speed bumps, or the like) into another form of energy which is then dissipated. Most shock absorbers are a form of dashpot (a damper which resists motion via viscous friction).

The linkage 100 is shown in illustrated embodiment in an upward configuration (with the swing arm 304 pushed upward against the shock absorber 302). The link 104 positions superiorly to the swing arm 304 in an upward configuration.

FIG. 4 is an environmental, side perspective view of a cycle linkage 400 in a downward configuration in accordance with the present invention (with the swing arm 304 pushed downward away from the shock absorber 302). As shown, in the downward configuration, the link 104 also positions superiorly to the swing arm 304, as does the link 102, preventing inferior positioning below the swing arm 304.

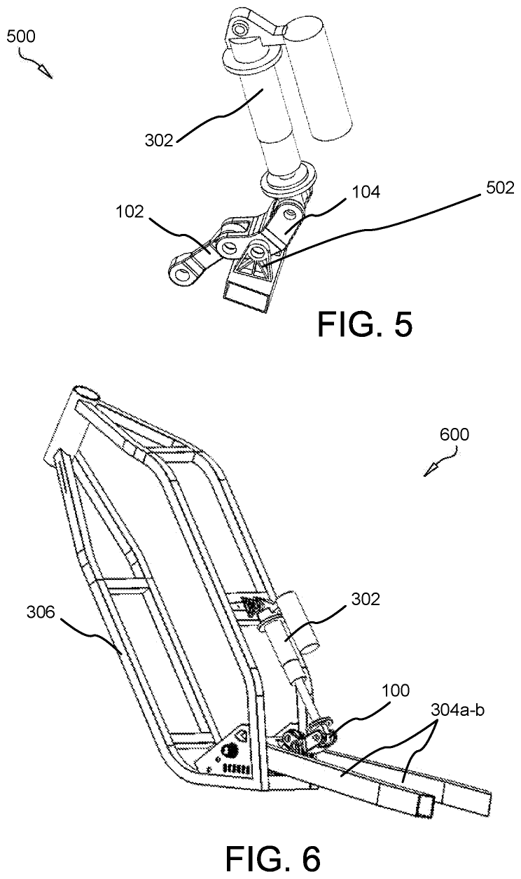

FIG. 5 is an environmental, side perspective view of a cycle linkage in an upward configuration in accordance with the present invention.

The link 104 joins an attachment point 502 on the swing arm 304. This joint is formed when the link 104 inserts into a bifurcate fork as shown, but the joint may be pivotably formed using any means known to those of skill in the art.

FIG. 6 is an environmental, side perspective view of a cycle linkage 600 in a downward configuration in accordance with the present invention.

The trailing link 102 and the chevron-shaped link 104 extend vertically through a recess in cycle body 306 and in the swing arm 304, thus supporting the shock absorber 302 in a substantially parallel orientation with a top tube of the frame, perpendicular the transverse link pivot axis 308 defined by the trailing link 102 and the cycle body frame 306.

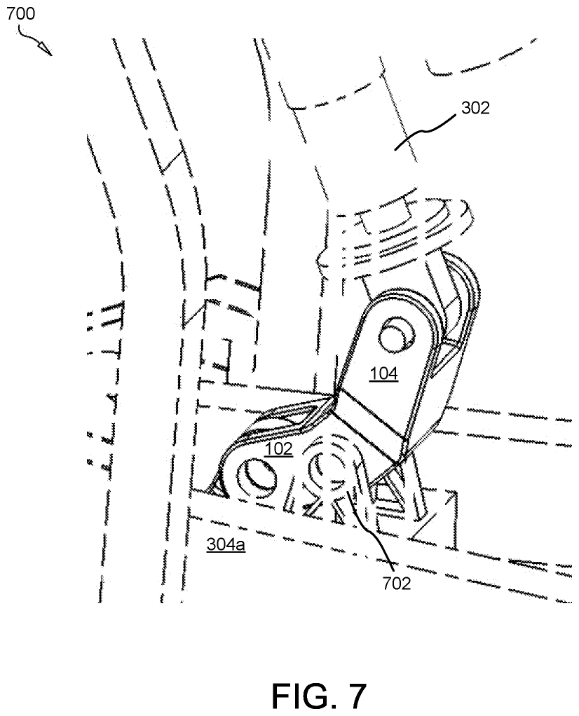

FIG. 7 is an environmental, isometric perspective view of a cycle linkage in an upward configuration in accordance with the present invention.

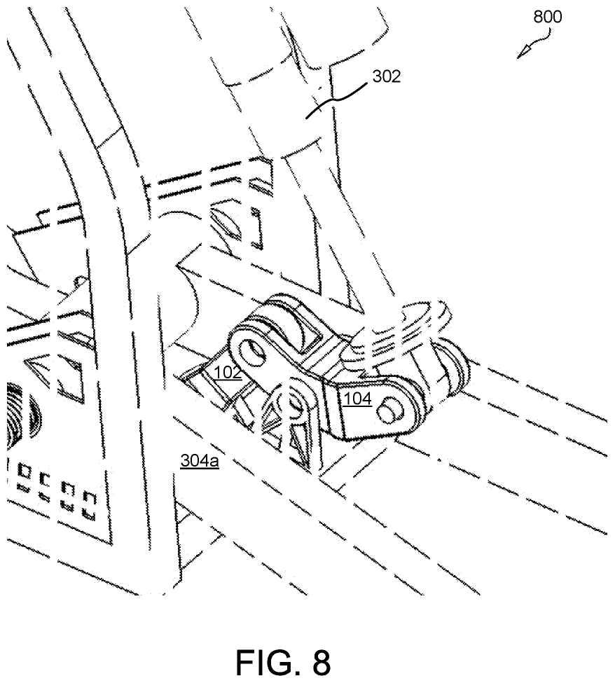

Broken lines are shown in FIGS. 7-8 to show unclaimed environmental perspective. The attachment point 502 includes a bifurcate bracket 702.

FIG. 8 is an environmental, isometric perspective view of a cycle linkage in a downward configuration in accordance with the present invention.

Even in a downward configuration, the link 104 and link 102 remain superior to the swing arm 304.

It should be noted that the link 102 pivots axially about the transverse axis 308 on the same plane as the link 104 (“in plane with” link 104 or “co-planarly”). This is the same plane within which the shock absorber 302 retracts and articulates. As such, the link 102, the link 104, and the shock absorber all articulate in plane with one another, said plane orthogonal to the transverse axis 308 and a ground surface upon which the cycle rests or rides.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

What is claimed is:

1. A progressive linkage suspension assembly adapted to suspend a swing arm pivotably connected to a cycle body frame, the linkage suspension assembly comprising:
a first link pivotably affixed to cycle body frame at a distal end, the first link defining a bore at the distal end, the first link pivotably affixed to a chevron-shaped second link having a distal end and a proximal end;
the chevron-shaped second link hingedly affixed at a midpoint to a swing arm and adapted to seesaw about the midpoint, the chevron-shaped link having a proximal end comprising a bifurcate bracket adapted to affix to a shock absorber, the chevron-shaped link defining:
a distal bore at a distal end of the chevron-shaped link adapted to hingedly affix to the first link; and
a proximal bore at the proximal end adapted to hingedly affix the bifurcate bracket to the shock absorber;
wherein the first link and the chevron-shaped link both articulate on separate axes transverse to the cycle body frame.

2. The linkage assembly of claim 1, wherein the distal end of the chevron-shaped link further comprises a second bifurcate bracket adapted to hingedly affix the chevron-shaped link to the first link.

3. The linkage assembly of claim 1, wherein the midpoint of the chevron-shaped link is inferior to the distal bore and the proximal bore.

4. The linkage assembly of claim 1, wherein a distance between the midpoint of the chevron-shaped link and the proximal bore of the chevron-shaped link exceeds the distance between the midpoint and the distal bore of the chevron-shaped link.

5. The linkage assembly of claim 1, wherein in both upward and downward configurations the linkage assembly rises superiorly to the swing arm.

6. A progressive linkage suspension assembly adapted to suspend a swing arm pivotably connected to a cycle body frame, the linkage suspension assembly comprising:
a first link pivotably affixed to cycle body frame at a distal end, the first link defining a bore at the distal end, the first link pivotably affixed to a second link having a distal end and a proximal end;
the second link hingedly affixed at a midpoint to a swing arm and adapted to seesaw about the midpoint, the second link having a proximal end comprising a bifurcate bracket adapted to affix to a shock absorber, the second link defining:
a distal bore at a distal end of the second link adapted to hingedly affix to the first link; and
a proximal bore at the proximal end adapted to hingedly affix the bifurcate bracket to the shock absorber;
wherein the first link and the second link both articulate on separate axes transverse to the cycle body frame.

7. The linkage assembly of claim 6, wherein the second link is one of bowed, triangular, and chevron-shaped from a side perspective.

8. The linkage assembly of claim 6, wherein the midpoint of the second link is inferior to the distal bore and the proximal bore.

9. The linkage assembly of claim 6, wherein a distance between the midpoint of the second link and the proximal bore of the second link exceeds the distance between the midpoint and the distal bore.

10. The linkage assembly of claim 9, wherein the distance between the midpoint of the second link and the proximal bore of the second link exceeds the distance between the midpoint and the distal bore by 10%-400%.

11. The linkage assembly of claim 6, wherein in both upward and downward configurations the linkage assembly rises superiorly to the swing arm.

12. The linkage assembly of claim 6, wherein the distal end of the chevron-shaped link further comprises a second bifurcate bracket adapted to hingedly affix the chevron-shaped link to the first link.

13. The linkage assembly of claim 6, wherein the first link and the second link pivot co-planarly with the shock absorber.

14. A progressive linkage suspension assembly adapted to suspend a swing arm pivotably connected to a cycle body frame, the linkage suspension assembly comprising:
a first link pivotably affixed to cycle body frame at a distal end, the first link defining a bore at the distal end, the first link pivotably affixed to a second link having a distal end and a proximal end;
the second link hingedly affixed at a midpoint to a swing arm and adapted to seesaw about the midpoint, the second link having a proximal end comprising a bifurcate bracket adapted to affix to a shock absorber, the second link defining:
a distal bore at a distal end of the second link adapted to hingedly affix to the first link; and
a proximal bore at the proximal end adapted to hingedly affix the bifurcate bracket to the shock absorber;
wherein the first link and the second link both pivot in co-planarly with the shock absorber.

15. The linkage assembly of claim 14, wherein a distance between the midpoint of the second link and the proximal bore of the second link exceeds the distance between the midpoint and the distal bore such that longitudinal movement of the proximal end of first link within plane is exaggerated with respect to longitudinal movement the proximal end of the second link within plane.
